(19) United States
(12) Patent Application Publication
(10) Pub. No.: US 2023/0030305 A1
(43) Pub. Date: Feb. 2, 2023

(54) GRAPHENE NANOPLATELET BATTERIES, APPARATUS, AND COMPOSITIONS

(71) Applicants: Nant Holdings IP, LLC, Culver City, CA (US); Directa Plus, S.p.A., Lomazzo (IT)

(72) Inventors: Patrick Soon-Shiong, Culver City, CA (US); Giulio Giuseppe Cesareo, Lomazzo (IT); Laura Giorgia Rizzi, Lomazzo (IT)

(21) Appl. No.: 17/874,747

(22) Filed: Jul. 27, 2022

Related U.S. Application Data
(60) Provisional application No. 63/274,791, filed on Nov. 2, 2021.
(60) Provisional application No. 63/228,557, filed on Aug. 2, 2021.
(60) Provisional application No. 63/226,116, filed on Jul. 27, 2021.

(51) Int. Cl. C01B 32/192; H01M 10/36; H01M 10/0525

(52) U.S. Cl. CPC C01B 32/192; H01M 10/36; H01M 10/0525; C01P 2006/40; C01P 2004/64

(57) ABSTRACT

Devices and methods are presented that comprise graphene platelets with controlled dimension and high carbon to oxygen ratio, and that further include a heteroatom or heteroionic species, an alkylammonium polysulfide, or both, preferably non-covalently bound to the graphene platelets. Such compositions have significantly improved conductive properties as opposed to unmodified graphene platelets and can be easily produced at mass quantities and low cost.

### CROSS REFERENCE TO RELATED APPLICATIONS

This application claims the benefit of U.S. Provisional Application Nos. 63/226,116, 63/228,557, and 63/274,791, filed Jul. 27, 2021, Aug. 2, 2021, and Nov. 2, 2021, respectively, the contents of which are hereby incorporated by reference herein in their entirety.

### FIELD OF THE INVENTION

The field of the invention is various electrochemical devices and methods thereof, and especially as it relates to devices and methods that may use sulfur-modified nanostructured carbon electrodes and/or separators.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Graphene has found since its discovery numerous applications in a wide variety of materials, and graphene products have now entered the mainstream. Despite its simple structure and wide availability of source materials (e.g., highly ordered graphite), dimensional control and oxygen content (e.g., as hydroxide or carboxylate group) is notoriously difficult to control. More recently, advances were made to control these factors as is described, for example, in U.S. Pat. Nos. 10,457,557 and 10,773,954 where the inventors disclosed certain methods of producing graphene under dimensional control and desirable carbon to oxygen ratios (e.g., at least 100:1). Advantageously, such graphene formulations were shown to have good electrical conductivity when formed in a layer on a carrier material. Nevertheless, due to the inherent electrochemical properties of graphene, certain parameters of use of graphene in redox reactions and battery electrodes such as resistance to oxidation and electron transfer off the graphene layer are less than desirable.

To improve such parameters, graphene can be doped with heteroatoms. Among other heteroatoms, sulfur-doped graphene has become a material of choice for the development of electrochemical reaction surfaces. In terms of sulfur doping, according to density functional theory (DFT), sulfur atoms can conceptually exist in various forms in doped graphene: adsorbed to the graphene surface, as substitution of graphene edge carbon atoms, within the formation of S/S oxides, and within sulfur clusters located between aromatic rings of two graphene layers (Science of The Total Environment, Volume 698, 1 Jan. 2020, 134239).

For example, sulfur doped graphene was produced that acted as an efficient metal-free cathode catalyst for oxygen reduction (see ACS Nano 2012, 6, 1, 205-211). Here sulfur atoms were identified to replace carbon atoms in the fabric of a graphene layer. In another example, sulfur-doped graphene was prepared in a concurrent doping/exfoliation process to generate supercapacitor electrode materials (see J. Mater. Chem. A, 2016,4, 233-240). Here once more, sulfur was directly bound to neighboring carbon atoms at the edge or center of a graphene layer. In yet another report (see Angew Chem Int Ed Engl. 2020 May 11; 59(20):7836-7841), sulfur enriched graphene was produced using graphene oxide treated with Lawson's reagent. While advantageous in at least some aspects, production methods tend for such materials to be time and capital intensive and tend to fail to provide dimensional control. In addition to difficulties with conventional production of sulfur doped graphene, sulfur doped graphene typically exhibits a polysulfide shuttle effect that limits the usefulness and life time of lithium sulfur batteries.

Thus, even though various systems and methods of heteroatom-doped graphene are known in the art, all or almost all of them suffer from several drawbacks. Therefore, there remains a need for compositions and methods for heteroatom-doped graphene that provides dimensional control, preferably at high carbon to oxygen ratios, and that allow for a simple yet effective process of manufacture.

### SUMMARY OF THE INVENTION

In one embodiment, the inventive subject matter is directed to various compositions and methods of heteroatom-doped graphene with control of graphene dimensions (e.g., morphology, size, shape, surface area, volumes, etc.), typically at a high carbon to oxygen ratio. As will be readily appreciated, the heteroatom may be any atom or even ionic component, and may be incorporated via adsorption and/or carbon atom substitution. Among other options, preferred heteroatoms include those with an electronegativity similar to carbon such as boron, indium, vanadium, phosphorus, sulfur, and/or selenium, but various other heteroatoms are also deemed suitable for use herein, including noble metals and semi (conducting) metals.

In one aspect of the inventive subject matter, the inventors contemplate an active material that includes a plurality of graphene platelets (e.g., nano-plateletes, etc.) to which are coupled a plurality of heteroatoms and/or heteroionic species. Most typically, but not necessarily, the graphene platelets have a lateral size from 50 to 50,000 nm and a thickness from 0.34 to 50 nm, and a carbon to oxygen ratio of at least 50, and more typically of at least 100 and even higher.

In some embodiments, the plurality of heteroatoms are selected from but not limited to boron, sulfur, selenium, tellurium, antimony, germanium, gallium, indium, aluminum, and zinc. For example, where the heteroatoms are elemental sulfur, it is preferred that the sulfur is predominantly present in an octagonal ring form. In other embodiments, the heteroionic species is an anionic species or a metal oxide (e.g., a sulfate or nitrate species or the metal oxide comprises cobalt or manganese). It is further contemplated that at least some, and more typically the majority of the heteroatoms are non-covalently adsorbed to the graphene platelets.

In another aspect of the inventive subject matter, the inventors contemplate a method of preparing a graphene material that includes a step of providing expanded graphite flakes in a liquid dispersant, and a further step of admixing a plurality of heteroatoms and/or heteroionic species with the graphite flakes to so generate a mixed dispersion. In yet another step, the mixed dispersion is subjected to high-pressure homogenization under conditions that produce a plurality of graphene platelets to which then the plurality of heteroatoms and/or heteroionic species are coupled. Most preferably, but not necessarily, the graphene platelets may have a lateral size from 50 to 50,000 nm and a thickness from 0.34 to 50 nm.

As will be readily appreciated, the expanded graphite flakes can be produced by thermal expansion of intercalated graphite. Moreover, it is contemplated that suitable heteroatoms include boron, sulfur, selenium, and zinc, and/or that the heteroionic species may be an anionic species or a metal oxide. In further preferred aspects, it is contemplated the graphene platelets have a carbon to oxygen ratio of at least 50, and more preferably at least 100. While not limiting the inventive subject matter, it is generally contemplated that at least some, and more typically the majority of the plurality of heteroatoms are non-covalently adsorbed to the graphene platelets. Furthermore, it is generally preferred that the plurality of heteroatoms will be in form of micro- or nanometer sized particles in the step of admixing.

As needed or desired, contemplated methods may also include a step of removing at least a portion of the dispersant. Preferably, but not necessarily, the dispersant is an aqueous solution (e.g., the dispersant is water).

Consequently, the inventors also contemplate an electrode that comprises the graphene material as described herein. For example, suitable electrodes may be configured as a cathode of a battery (and most preferably of a lithium ion or lithium sulfur battery). In other examples, the electrode can also be configured as an electrode of a fuel cell. Therefore, the inventors contemplate an energy storage device that includes an electrode as presented herein, and suitable devices include a lithium ion or lithium sulfur battery, or a capacitor.

In still another aspect of the inventive subject matter, the inventor contemplates a method of tuning conductivity of a battery electrode that includes a step of providing a conductive substrate and another step of conductively coupling to the substrate an active material and/or a graphene material as presented herein, wherein the quantity and type of heteroatom and/or heteroionic species in the graphene material is selected to so achieve a predetermined conductivity.

Similarly, the inventors also contemplate a method of improving electrochemical stability of a graphene electrode that includes a step of providing a conductive substrate, and conductively coupling to the substrate a graphene material as presented herein, wherein the quantity and type of heteroatom and/or heteroionic species in the graphene material is selected to so improve the electrochemical stability of the electrode.

In yet another aspect of the inventive subject matter, the graphene will be coated with sulfur in an S₈ allotrope, and it is particularly preferred that the sulfur is deposited from a precursor that preferably uniformly coats or surrounds the graphene. Thusly prepared materials are expected to have superior electrochemical properties (e.g., conductivity, chemical stability) and can be implemented in a variety of electrochemical devices, and especially lithium sulfur batteries. Moreover, in addition to improved sulfur modified graphene, the inventors contemplate that separators can be implemented in lithium sulfur batteries (with or without improved sulfur modified graphene) that comprise a polysulfide layer on a separator that significantly reduces the polysulfide shuttle due to electrostatic repulsion.

In various embodiments, the inventors contemplate a reaction intermediate for production of a graphene material that comprises a plurality of graphene platelets dispersed in a solvent that comprises alkylammonium polysulfides, wherein the graphene platelets having a lateral size from 50 to 50,000 nm and a thickness from 0.34 to 50 nm, and wherein the graphene platelets have a carbon to oxygen ratio of at least 50.

In some embodiments, the alkylammonium polysulfides have the general formula of (R—NH₃⁺)(R—NH—S₈⁻), wherein R is an optionally substituted alkyl or aryl (e.g., ethylene diamine). Preferably, the alkylammonium polysulfides are formed from a reaction between ethylenediamine and sulfur, and the intermediate may further comprise an acid (e.g., HCl) in a quantity sufficient to decompose at least some of the alkylammonium polysulfides to thereby deposit sulfur in an S₈ form onto the graphene platelets. Therefore, it is generally contemplated that the majority of the sulfur is non-covalently adsorbed to the graphene platelets. Most typically, but not necessarily, the graphene platelets have a carbon to oxygen ratio of at least 100.

Viewed from a different perspective, it should therefore be recognized that the inventor contemplates a method of preparing a sulfur-modified or possibly selenium-modified graphene material that includes a step of providing expanded graphite flakes in a liquid dispersant, and a further step of subjecting the dispersion to high-pressure homogenization under conditions that produce a plurality of graphene platelets. Most typically, the graphene platelets have a lateral size from 50 to 50,000 nm and a thickness from 0.34 to 50 nm. In such methods it is further contemplated that, during and/or after the step of high-pressure homogenization, the graphene platelets are contacted with alkylammonium polysulfides to thereby coat at least some of the graphene platelets with the alkylammonium polysulfides. Subsequently or simultaneously, an acid is added to the coated graphene platelets in a quantity sufficient to decompose at least some of the alkylammonium polysulfides to thereby deposit sulfur in an S₈ form onto the graphene platelets. One should appreciate that selenium compounds are also contemplated.

In yet another embodiment the inventors contemplates a method of preparing a doped graphene material that includes an element selected from but not limited to boron, sulfur, selenium, tellurium, antimony, germanium, gallium, indium, aluminum and zinc a step of providing expanded graphite flakes in a liquid dispersant, and a further step of subjecting the dispersion to high-pressure homogenization under conditions that produce a plurality of graphene platelets. Most typically, the graphene platelets have a lateral size from 50 to 50,000 nm and a thickness from 0.34 to 50 nm. In such methods it is further contemplated that, during and/or after the step of high-pressure homogenization, the graphene platelets are contacted with alkylammonium polysulfides to thereby coat at least some of the graphene platelets with the alkylammonium polysulfides. Subsequently or simultaneously, an acid is added to the coated graphene platelets in a quantity sufficient to decompose at least some of the alkylammonium polysulfides to thereby deposit sulfur in an S₈ form onto the graphene platelets. One should appreciate that selenium compounds are also contemplated.

For example, expanded graphite flakes in such methods are produced by thermal expansion of intercalated graphite, and/or the graphene platelets have a carbon to oxygen ratio of at least 50, or of at least 100. It is further contemplated that the alkylammonium polysulfides are added to the graphene platelets in a dispersant (e.g., aqueous solution), and/or that at least a portion of the dispersant is removed after depositing the sulfur onto the graphene platelets.

In further embodiments, the inventor contemplates an electrode comprising the graphene materials as presented herein. Additionally, the electrode may also comprise a plurality of multiwall carbon nanotubes to which sulfur in S₈ form is bound and/or a plurality or porous aragonite particles to which sulfur in S₈ form is bound. As will be appreciated, the electrode may be configured as a cathode of a battery (e.g., a lithium ion or lithium sulfur battery) or a fuel cell.

In other embodiments the inventors also contemplate a separator for an electrochemical device having a single sided or double sided coating that comprises an aragonite or vanadyl phosphate, or further comprising polysulfide anions coupled to the vanadyl phosphate. In at least some embodiments, the aragonite is chemically bound to the separator and allows selective ionic transfer, e.g. lithium-ion transfer while blocking polysulfide shuttling, and in further embodiments the separator further comprises a polymeric material including poly-ethylene or poly-propylene.

Consequently, the inventor also contemplates a method of tuning conductivity of an electrode that includes a step of providing a conductive substrate, and conductively coupling to the substrate a graphene material as presented herein, wherein the quantity of the sulfur in the graphene material is selected to thereby achieve a predetermined conductivity. In some embodiments, the electrode is configured as a cathode of a battery or as a sensor.

In still further contemplated aspects, the inventor contemplates a method of improving electrochemical stability of an electrode that includes a step of providing a conductive substrate, and conductively coupling to the substrate a graphene material as presented herein, wherein the quantity of the sulfur in the graphene material is selected to thereby improve the electrochemical stability of the electrode. In some embodiments, the electrode is configured as a cathode of a battery or as a sensor. Therefore, it should be appreciated that various energy storage devices may comprise an electrode as presented herein. Among other choices, the energy storage device may be configured as a lithium sulfur or lithium selenium battery, and optionally comprising a DME/DOL electrolyte.

Where desired, the energy storage may further comprise a separator positioned between an anode and a cathode of the energy storage device, wherein the separator comprises a polysulfide-phobic material that can be coated onto a polymeric material or a ceramic material (e.g., polypropylene or polyethylene or a cellulosic material, optionally comprising aragonite).

Therefore, the inventor also contemplates a separator for an electrochemical device that comprises aragonite and vanadyl phosphate, and further comprising polysulfide anions coupled to the vanadyl phosphate. In at least some embodiments, the aragonite is chemically modified to thereby render the aragonite hydrophobic, and in further embodiments the separator further comprises a cellulosic material.

Various objects, features, aspects and advantages of the inventive subject matter will become more apparent from the following detailed description of preferred embodiments.

### DETAILED DESCRIPTION

The inventor has now discovered that dimensionally controlled graphene platelets with high carbon to oxygen ratio can be modified with one or more heteroatoms and/or heteroionic species, and particularly sulfur or possibly selenium in a conceptually simple and cost effective manner to so produce sulfur doped graphene compositions that have a variety of desirable properties, and especially electrochemical properties. Moreover, the inventor also contemplates modified separators for lithium sulfur batteries that substantially reduce polysulfide shuttle and increase mechanical and thermal stability, and with that significantly improve lithium sulfur battery life time.

In one particularly preferred aspect of the inventive subject matter, the inventors have shown that dimensionally controlled graphene platelets with high carbon to oxygen ratio can be produced in a combined process that first uses graphite exfoliation to produce expanded graphite flakes, and that then subjects the expanded graphite flakes in the presence of heteroatoms (e.g., in the form of micro- or nanosized sulfur particles) and/or heteroionic species (e.g., in the form of insoluble micro- or nanosized sulfate salts) to high-pressure homogenization to so produce a unique material in which the heteroatoms and/or heteroionic species become coupled to the graphene platelets, typically in a non-covalent manner.

With regard to suitable starting materials it should be appreciated that all kinds of carbonaceous materials are deemed suitable and especially preferred materials include graphite (e.g., highly ordered mined graphite), which may or may not be obtained as intercalated graphite. There are numerous manners of graphite intercalation known in the art, and all of these are deemed appropriate for use herein so long as such materials will produce a plurality of expanded graphite flakes. Therefore, it should be appreciated that the type of exfoliation may also vary considerably (e.g., chemical exfoliation with strong acid, microwave/plasma exfoliation, etc.), and the nature of exfoliation is generally not limiting to the inventive subject matter. However, it is generally preferred that the exfoliation will occur under conditions that reduce the amount of oxidative damage to the graphene plates. In still further contemplated aspects, and particularly where selenium is used as a dopant, the graphene may also be modified to include a number of holes distributed throughout the fabric of the monoatomic layers of graphene (see e.g., Adv. Funct. Mater. 25, 2920-2927. doi:10.1002/adfm.201500321, or Materials Res Lett. 2017 Vol 5, Issue 4; doi.org/10.1080/21663831.2016. 1271047, which is incorporated by reference herein in its entirety).

Regardless of the type of material and manner of production, it is then contemplated that the expanded graphite flakes are subjected to a high-pressure homogenization process in the presence of the heteroatoms and/or heteroionic species. While numerous manners of homogenization are deemed suitable for use herein, particularly preferred methods are described in U.S. Pat. Nos. 10,457,557 and 10,773,954, both of which are incorporated by reference herein in their entirety. In this context, it should be especially appreciated that the non-thermal high shear conditions in such methods will not only preserve a low oxidation of the graphene particles, but also enables intimate contact of the heteroatoms and/or heteroionic species with the graphene platelets.

Indeed, it is contemplated that the non-thermal high shear conditions also allow for intercalation of the heteroatoms and/or heteroionic species between two or more layers of the graphene planes and as such facilitate electron transport in a direction that is perpendicular to the plane of a graphene plane. In that context, it should further be recognized that the heteroatoms and/or heteroionic species will provide for facile electron transport in a manner as is known from sulfur (or other heteroatom-doped graphene). Consequently, numerous heteroatoms and/or heteroionic species are contemplate for use herein and among other options, suitable heteroatoms will have electrical (semi)conductivity and/or may have an electronegativity that is similar to carbon, that is lower, or higher. Therefore, and among other options, contemplated heteroatoms include boron, phosphorus, sulfur, selenium, tellurium, zinc, cadmium, silver, gold, palladium, platinum, iridium, and vanadium. Viewed from a different perspective, suitable heteroatoms may impart a catalytic or semiconductive function to the graphene material. Where it is desired to intercalate heteroatom(s) and/or heteroionic species within the graphene layers of graphene nanoparticles during high-pressure homogenization, it is contemplated that a mild chemical oxidant can be included in the homogenization liquid to so further promote intercalation.

In view of the above, it should therefore be appreciated that the heteroatom(s) and/or heteroionic species may be added at any time of the formation of the graphene nanoplatelet production process, including before exfoliation, during exfoliation, and after exfoliation. However, it is typically preferred that the heteroatom or heteroionic species (e.g., elemental sulfur in S₂₋₄ and/or S₈ form) is added before, concurrent with, or after high pressure homogenization. For example, elemental sulfur, typically micronized, may be added as an admixture to the graphene microplatelets after high pressure homogenization and the mixture may then be compressed to make a flat membrane or sheet (e.g., in a process similar to that for the formation of a zinc air battery membrane).

In further contemplated aspects, and especially where Se is used as a dopant heteroatom, it is contemplated that holey graphene (hG), a derivative of graphene, can be compressed from its dry powder form into robust solid architectures of various shapes to so form a host for other materials, and especially selenium (see e.g., Scaffolds. Batteries. Supercaps. 2, 774-783. doi:10.1002/batt.201900053, which is incorporated by reference herein in its entirety). Advantageously, dry compressibility is uniquely attributed to the nanometer-sized holes through the nanosheet surface, which originate from the intrinsic defects of the parent graphene, and therefore do not significantly affect the typical characteristics of graphene as an electrode material. With high electrical conductivity, high surface area, and mechanical robustness, hG has been shown to be an excellent and versatile scaffold material applicable for various forms of energy storage.

For example, dry-pressed neat hG electrodes are known for certain energy storage devices such as supercapacitors (see e.g., ACS Appl. Mater. Inter. 8, 29478-29485. doi:10.1021/acsami.6b09951, which is incorporated by reference herein in its entirety) and air cathodes for lithium-oxygen (Li—O₂) batteries (see e.g., Nano Lett. 17, 3252-3260. doi:10.1021/acs.nanolett.7b00872). hG can also serve as an effective host for dry-pressed composite electrodes with active materials from both intercalation (e.g., lithium iron phosphate (LFP) and lithium nickel cobalt manganese (NCM)) and conversion (e.g., S) chemistries (see e.g., Scaffolds. Batteries. Supercaps. 2, 774-783. doi:10.1002/batt.201900053, which is incorporated by reference herein in its entirety). In that context, it should be particularly appreciated that the dry-press electrode fabrication procedure is facile and does not require the use of any solvent or binder. Therefore, the resultant electrodes exhibit excellent performance with high active material utilization due to the effectiveness of the conductive hG scaffold. With the unique dry compression electrode fabrication approach, the use of hG is particularly beneficial for high-quality, high mass loading electrodes that are required in practical applications, and particularly high mass loading of selenium and/or sulfur in cathodes for lithium sulfur and lithium selenium batteries. Of course, it should be appreciated that lithium and sulfur may be present in various ratios in such cathodes, however, it is contemplated that selenium may be the predominant, if not exclusive component.

Moreover, it is contemplated that the graphene doping may also be performed from a precursor material that is decomposed or otherwise reacted in the presence of the graphene to produce elemental sulfur, and especially sulfur in an S₈ allotrope. Therefore, and among other precursors, particularly contemplated precursors include sulfur amine compounds that bind elemental sulfur to so form an alkylammonium polysulfide. Advantageously, the so prepared alkylammonium polysulfides are dissolved in a solution and as such can form a uniform carrier for a graphene suspension. Viewed from a different perspective, it should be appreciated that graphene platelets can be uniformly coated with a sulfur dopant at very high densities to thereby allow, upon decomposition of the precursor, uniform coating of the graphene with elemental sulfur at high concentrations.

In most typical embodiments, the alkylammonium polysulfide is prepared from an alkyl amine reagent and elemental sulfur according to equation (1)

2(R—NH₂)+S₈→(R—NH₃⁺)(R—NH—S₈⁻) Eq. 1

wherein R is an alkyl, typically a short-chain alkyl having between 2-8 carbon atoms, which may be further substituted with an amine group, a halogen group, a sulfate groups, a hydroxyl group, etc., or wherein R is an aryl, alkaryl, or heteroaryl in which 5 or six atoms form a ring, and in which two or more rings can be annulated. It should be noted, however, that the same reaction with selenium in place of sulfur can also be performed, preferably using Se₆, Se₇, and/or Se₈ allotropes. The so prepared alkylammonium polysulfide can then be admixed with the graphene either before, during, or after the high-pressure homogenization to so form a reaction intermediate that can then be subjected to a subsequent reaction in which the sulfur is deposited onto the graphene platelets. Most preferably, the decomposition reaction is a reaction with an acid (e.g., hydrochloric acid, sulfuric acid, phosphoric acid, or one or more organic acids) according to equation (2)

(R—NH₃⁺)(R—NH—S₈⁻)+HCl→2(R—NH₃⁺)+S_{8 (solid)} Eq. 2

wherein R is defined as noted above, and where sulfur can be replaced with selenium to so form sulfur/selenium doped graphene (or other carbon allotropes). As will be readily appreciated, the same reaction can also be performed using metal doped graphene, and numerous non-graphene carbon allotropes such as single walled carbon nanotubes, multiwalled carbon nanotubes, and buckminsterfullerenes.

Consequently, it should be appreciated that various high-surface carbon nanostructures with high sulfur doping can be prepared in a simple and effective manner where the sulfur is deposited in a substantially uniform distribution at very high sulfur concentrations. Where desired, the so sulfur doped graphene and other materials can be further modified, for example, by reaction with polyaniline via in situ polymerization to form a composite material. Suitable reagents, reaction conditions, and further considerations are described in Chem. Commun., 2014, 50, 1202 (DOI: 10.1039/c3cc47223j), which is incorporated by reference herein in its entirety.

Among other options, after the high-pressure homogenization (HPH) step the liquid dispersion of graphene nanoplatelets (GNPs) may be filter pressed to at least partially remove the liquid, therefore increasing the GNP concentration. Most typically, the final concentration of the liquid will then range from 15 to 30 wt %, more preferably from 20 to 25 wt % (to so produce a paste form that can be used in further downstream manufacturing processes).

On the other hand, it should also be noted that the GNPs in paste form could be added to a liquid dispersion containing the target heteroatom(s)/heteroionic species. As will be readily appreciated, such composition can be realized by mechanical mixing using a cowls mixer, a rotor-stator blender, or a high-pressure homogenizer. In this step it is also possible to add one or more chemical components that promote the interaction between GNPs and the heteroatom or heteroionic species. Moreover, the pressure and temperature can also be used to promote this interaction. Where desired, other conductive agents, binders, and viscosity adjusting agents can be added. After mixing, a baking step can be performed to remove the residual liquid. Such baking will preferably be performed after the paste has been molded or otherwise shaped into a suitable configuration. Thus, it should also be appreciated that the GNP slurry or paste can be shaped into any desired form, for example, by spraying, coating, or molding to so achieve any desired geometry (which is especially desirable for electrode manufacture). In still further contemplated aspects, the heteroatom(s) or heteroionic species may also be applied to the final geometry (before or after drying). In such methods, it should be recognized that the distribution of the heteroatom(s) or heteroionic species can be graduated or isotropic. Consequently, contemplated materials may be employed in a variety of devices other than batteries, and especially suitable devices include sensors (e.g., to determine conductivity, resistivity, galvanic responses, etc.)

In still further contemplated embodiments, dry-state mixing is also contemplated where GNPs in powder form are directly combined with the heteroatom(s) and/or heteroionic species. For example, suitable dry mixing systems include turbo mixing, ball or rod milling, jet milling, etc. After the dry mixing, the GNPs with heteroatom(s)/heteroionic species can be dispersed in a liquid for further processing and/or to add other ingredients.

Likewise, in yet further contemplated embodiments, dry-state mixing is also contemplated where GNPs in powder form are directly combined with the alkylammonium polysulfide in a manner as already described above. For example, suitable mixing systems will typically use a liquid carrier (e.g., same carrier as that for the alkylammonium polysulfide) in which the graphene nanoplatelets are mixed with the alkylammonium polysulfide solution. Thus, mixing systems will include static mixers, rotary mixers, ultrasonic mixers, etc. After mixing, the sulfur doped GNPs can be combined with further ingredients. As will be readily appreciated, the solvent or dispersant can be removed from the mixture after sulfur deposition to so form the sulfur modified graphene. Once more, it should be noted that the sulfur modified graphene can be subjected to subsequent reactions for forming a suitable composite material.

As noted before, it is contemplated that the compositions presented herein need not exclusively comprise graphene nanoplatelets, but may also include other carbon allotropes, and especially contemplated allotropes include single-walled and multi-walled carbon nanotubes (which may or may not be coupled to the same or different heteroatom or heteroionic species), fullerenes with C₂₀ to C₁₀₀ (and even larger, but most typically C₆₀). Such distinct allotropes will advantageously allow modification of thermal and/or electrochemical properties, help generate porosity while maintaining the same chemical footprint. In still further contemplated aspects, the carbon allotrope is diamond and may be provided as grit, microdiamonds, and/or nanodiamonds, for example, where mechanical/dimensional stability or thermal conductivity is desired.

Most typically, but not necessarily, the heteroatoms will be provided as finely comminuted material. In most cases, and especially where the heteroatom is a metallic material, the heteroatoms may be provided as nano-scaled or quantum dot-type materials having between 10 and 2,000 atoms, or between 50 and 5,000 atoms, or more. On the other hand, and particularly where the shear conditions can disrupt the initial particle size, the heteroatom may be provided as a micro-or nanometer sized particle. For example, suitable particle sizes for a plurality of heteroatoms will be between 1-10 nm, or between 10-100 nm, or between 100-500 nm, or between 500 and 1,000 nm, or between 1 and 10 μm, or between 10 and 100 μm, or between 100 and 500 μm, and even larger.

Regardless of the particular size distribution of the heteroatoms, it is contemplated that the heteroatoms will be present in a weight ratio (heteroatom:graphene platelet) of at least 1:1, and more typically between 1:10 and 1:100, or between 1:100 and 1:500, or between 1:500 and 1:1,000, or between 1:1,000 and 1:10,000, or between 1:5,000 and 1:50,000, and even higher.

Likewise, where a heteroionic species is included, it is generally preferred that the heteroionic species will be a (typically) insoluble salt form of the anion (e.g., BaSO₄, etc.), or in form of metal oxides or transition metal suboxides, and with regard to the size and quantity the same considerations as noted above apply. On the other hand, the heteroionic species may also be introduced by esterification of a corresponding acid (e.g., nitric acid, etc.) with residual hydroxyl groups on the graphene. In such case, the heteroionic species will be covalently bound to the graphene platelet. In general, it should be appreciated, however that due to the high shear force process, the location of the heteroatoms and/or heteroionic species is not limited to edge portions of the graphene platelets, but may typically (and in some or most cases) include positions between graphene layers within one graphene platelet.

Consequently, and in view of the above, it should be appreciated that the electrical conductivity and electrochemical stability of graphene (and all materials and structures produced therefrom) can be tuned or improved by tailored inclusion of one or more heteroatoms and/or heteroionic species, via one or more properties include the dimensionality or morphology of the graphene platelets, spheres, tubes, or other nano-particles (e.g., Bucky balls, nanotubes, etc.).

Indeed, it is contemplated that the plurality of graphene platelets, which include the heteroatom or heteroionic species, the alkylammonium polysulfide, or both, preferably non-covalently bound to the graphene platelets, may include a plurality of nanotubes coupled to the platelets. In certain embodiments the plurality of nanotubes are disposed between two adjacent platelets and coupled thereto. The plurality of nanotubes may include the heteroatom or heteroionic species, the alkylammonium polysulfide, or both, preferably non-covalently bound to the nanotubes. In various embodiments, the plurality of heteroatoms and/or heteroionic species are coupled to the plurality of graphene platelets, the plurality of graphene platelets are dispersed in a solvent that comprises alkylammonium polysulfides, or both. In these and other embodiments, the plurality of heteroatoms and/or heteroionic species are coupled to the plurality of nanotubes, the plurality of nanotubes are dispersed in a solvent that comprises alkylammonium polysulfides, or both.

It should be appreciated that various high-surface carbon nanostructures with high sulfur doping can be prepared in a simple and effective manner where the sulfur is deposited in a substantially uniform distribution at very high sulfur concentrations on the plurality of graphene platelets and the plurality of nanotubes for exponentially increasing surface area of the nanostructures. Suitable compositions, structures, reagents, reaction conditions, and further considerations are described in Advanced Functional Materials, 2016, 26(46), 8418-8426. (doi:10.1002/adfm.201604069), which is incorporated by reference herein in its entirety.

Consequently, the inventors particularly contemplate electrodes that comprise at least a layer of the composite active material presented herein. Such electrodes may, of course, be found in a variety of devices such as electrochemical reactors, fuel cells, capacitors, and a variety of batteries. Among other battery formats, especially contemplated batteries that include the modified graphene platelets include lithium ion batteries, lithium sulfur batteries, lithium selenium batteries, zinc/air batteries, iron/air batteries, etc. In this context, it should be also appreciated that the materials presented herein will present a significant improvement over currently known modified graphene oxide materials (see e.g., U.S. Pat. Nos. 9,673,452 and 10,044,031, both of which are incorporated by reference herein in their entirety), especially where sulfur is the heteroatom in the active materials as described herein. For example, the disclosed batteries would weigh less than traditional batteries. Such light weight batteries would be advantageous for weight sensitive vehicles possibly including airborne drones, UAV, airplanes, boats, or other weight sensitive devices. Viewed from a different perspective, it should be appreciated that the graphene materials as presented herein can be used on an anode and a cathode of a battery or capacitor, and especially in lithium ion batteries (see e.g., U.S. Pat. No. 9,853,284, which is incorporated by reference herein in its entirety) and in lithium sulfur batteries.

Where the composite active materials and/or modified graphene materials as presented herein are employed in a lithium sulfur battery, it should be appreciated that all types of lithium sulfur batteries are deemed suitable. Therefore, contemplated lithium sulfur batteries will typically include a solid lithium metal anode that is separated from the cathode by a separator and a non-aqueous (typically organic) electrolyte. With respect to the sulfur in such batteries it should be recognize that the sulfur will be in elemental form, and most typically in form of S₈ rings. However, in at least some aspects, the sulfur may also be present in S₂ or S₄ forms, or all reasonable combinations thereof. While contemplated sulfur and/or other heteroatom doped graphene described herein are generally deemed suitable for use with a number of different lithium sulfur battery configurations as noted before, sulfur and/or other heteroatom doped graphene is thought to be particularly advantageous for use in lithium sulfur batteries with structurally improved current collectors and/or separators as disclosed in U.S. Pat. Nos. 10,957,956 and 10,763,481, both of which are incorporated by reference herein in their entirety.

There are various cathode configurations for lithium sulfur batteries known in the art, and all of those are deemed suitable for use herein. Most notably, sulfur loading in currently known cathodes has presented somewhat of a limiting step, and it should be recognized that the heteroatom loading of graphene nanoplatelets as presented herein will present a technologically simple and economically attractive process that is readily adaptable to a variety of cathode configurations. For example, cathodes may be prepared form microporous and/or mesoporous carbon FDU materials containing sulfur in various forms (see e.g., Insight into the Electrode Mechanism in Lithium-Sulfur Batteries with Ordered Microporous Carbon Confined Sulfur as the Cathode; Adv. Energy Mater. 2013; DOI: 10.1002/aenm.201301473, which is incorporated by reference herein in its entirety) where the materials further comprise the sulfur-loaded graphene nanoparticles as described herein.

In still further contemplated cathode configurations for lithium sulfur batteries, the cathodes may comprise a multidimensional network on graphene nanoparticles carbon nanotubes as described elsewhere (see e.g., High-Performance Lithium Sulfur Batteries Based on Multidimensional Graphene-CNT-Nanosulfur Hybrid Cathodes; Batteries 2021, 7, 26.). Here, the graphene nanoparticles may be replaced or complemented by those as described above where sulfur is used as the heteroatom. Alternatively, lithium sulfur battery cathodes may also comprise metal-organic framework materials that may be functionalized and that comprise graphene nanoparticles with sulfur as the heteroatom (see e.g., Graphene-Metal-Organic Framework Composite Sulfur Electrodes for Li—S Batteries with High Volumetric Capacity; ACS Appl. Mater. Interfaces; URL: dx.doi.org/10.1021/acsami.0c09622). Once more, the graphene nanoparticles as presented herein, loaded with sulfur as the heteroatom, may advantageously be employed in such cathodes.

Regardless of the particular type of electrode configuration, it is contemplated that the electrochemical devices (e.g., primary/secondary batteries, fuel cells, electrochemical reactors, etc.) that use the active materials presented herein can be configured as a wet cell or a dry cell. In still further contemplated aspects, the inventors contemplate that while the above cathode materials use sulfur as the heteroatom, various other heteroatoms may also be used, including Na, K, Rb, Li, P, Se, or Te.

In still further contemplated aspects, and particularly where the electric device is a lithium sulfur battery (preferably using the sulfur doped graphene materials), the inventor contemplates that battery performance can further be improved by reducing polysulfide shuttle or polyselenium shuttle via incorporation of polysulfides or polyselenides that are immobilized on a separator material. For example, in one embodiment the separator is made from a conventional polymeric material such as polypropylene (PP) or polyethylene (PE) that is coated with a layer of vanadyl phosphate (VOPO₄) that then reacts with sulfur contained in Li₂S₆ or selenium contained in Li₂Se₆²⁻ (typically dissolved in DME/DOL electrolyte). So immobilized S₆²⁻ and/or Se₆²⁻ is believed to provide sufficient electrostatic repletion to free polysulfides and/or polyselenides in the electrolyte to thereby prevent migration of the polysulfide and/or polyselenides across the separator membrane. One exemplary system for VOPO₄ modified PP or PE is described in Angew. Chem. Int. Ed. 2019, 58, 11774-11778 (DOI: 10.1002/anie.201906055), which is incorporated by reference herein in its entirety.

While modified PP and PE will beneficially reduce the polysulfide shuttle and/or polyselenides shuttle in lithium sulfide/selenide batteries, various disadvantages nevertheless remain with the use of polymeric materials in separators. Among other parameters, dimensional stability and thermal degradation continued to present challenges in high current operation (intentional or inadvertent due to cell shorting). Therefore, the inventor also contemplates that the polymeric separators can be replaced by dimensionally stable inorganic materials such as ceramic materials, and especially mesoporous aragonite.

For example, oxide ceramic materials can be prepared by sol/gel electrospinning to produce nanofibers that are subsequently calcined as is described in iScience 15, 185-195 May 31, 2019 (DOI: doi.org/10.1016/j.isci.2019.04.028), which is incorporated by reference herein in its entirety. Such materials can be used directly as a separator or be further modified as described in more detail below. In other examples, mesoporous aragonite may be milled to a desired size (e.g., 10-500 μm) and optionally combined with additional reagents (e.g., starch, binder suitable for sintering, etc.) to achieve a desired physicochemical property. Examples of starch separators that can be modified to include aragonite are described in Carbohydrate Polymer Technologies and Applications 1 (2020) 100001 (doi.org/10.1016/j.carpta.2020.100001), which is incorporated by reference herein in its entirety. As will be readily appreciated, such inorganic separator materials will have significantly higher temperature tolerance than polymeric materials. Moreover, polymeric materials can be subject to loss of dimensional stability, which is substantially less likely the case with inorganic materials such as oxide ceramics and aragonite. As suitable source for aragonite includes CalCean LLC (see URL www.calcean.com) and as described in U.S. patent application publication 2020/0308015 to Myers et al. titled “Oolitic Aragonite Beads and Methods Therefor”, filed Apr. 24, 2020, which is incorporated by reference herein in its entirety.

Moreover, it should be recognized that these and other inorganic materials can be further derivatized to achieve one or more desirable characteristics. Firstly, due to the specific chemical nature of ceramic oxides and aragonite, such materials can be readily modified with vanadylphosphate as noted above to so allow further derivatization with Li₂S₆ (typically dissolved in DME/DOL electrolyte) to immobilize S₆²⁻. Thusly modified inorganic separators are once more believed to reduce polysulfide shuttle in lithium sulfide batteries. Second, and where desired, the aragonite or other materials can be readily modified to render such modified materials more hydrophobic.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

1. A battery active material, comprising:
a plurality of graphene platelets to which are coupled a plurality of heteroatoms and/or heteroionic species;
wherein the graphene platelets have a lateral size from 50 to 50,000 nm and a thickness from 0.34 to 50 nm; and
wherein the graphene platelets have a carbon to oxygen ratio of at least 50.

2. The active material of claim 1, wherein the plurality of heteroatoms are selected from the group consisting of boron, sulfur, selenium, and zinc.

3. The active material of claim 1, wherein the plurality of heteroatoms comprise elemental sulfur in an octagonal ring form.

4. The graphene material of claim 1, wherein the heteroionic species is an anionic species or a metal oxide.

5. The active material of claim 1, wherein the heteroionic species is a sulfate or nitrate species or wherein the metal oxide comprises cobalt or manganese.

6. The active material of claim 1, wherein the graphene platelets have a carbon to oxygen ratio of at least 100.

7. The active material of claim 1, wherein the majority of the plurality of heteroatoms are non-covalently adsorbed to the graphene platelets.

8. An electrode comprising the active material of claim 1.

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A method of preparing a battery active material, comprising:
providing expanded graphite flakes in a liquid dispersant, and admixing a plurality of heteroatoms and/or heteroionic species with the graphite flakes to generate a mixed dispersion; and
subjecting the mixed dispersion to high-pressure homogenization under conditions that produce a plurality of graphene platelets to which are coupled a plurality of heteroatoms and/or heteroionic species;
wherein the graphene platelets have a lateral size from 50 to 50,000 nm and a thickness from 0.34 to 50 nm.

22. The method of claim 21, wherein expanded graphite flakes are produced by thermal expansion of intercalated graphite.

23. The method of claim 21, wherein the plurality of heteroatoms are selected from the group consisting of boron, sulfur, selenium, and zinc.

24. The method of claim 21, wherein the plurality of heteroatoms comprise elemental sulfur in an octagonal ring form.

25. The method of claim 21, wherein the heteroionic species is an anionic species or a metal oxide.

26. The method of claim 21, wherein the heteroionic species is a sulfate or nitrate species or wherein the metal oxide comprises cobalt or manganese.

27. The method of claim 21, wherein the graphene platelets have a carbon to oxygen ratio of at least 50.

28. The method of claim 27, wherein the graphene platelets have a carbon to oxygen ratio of at least 100.

29. The method of claim 21, wherein the majority of the plurality of heteroatoms are non-covalently adsorbed to the graphene platelets.

30. The method of claim 21, wherein the plurality of heteroatoms is in form of micro- or nanometer sized particles in the step of admixing.

31. The method of claim 21, further comprising a step of removing at least a portion of the dispersant.

32. The method of claim 21, wherein the dispersant is an aqueous solution.
